(19) United States
(12) Patent Application Publication
(10) Pub. No.: US 2018/0253510 A1
(43) Pub. Date: Sep. 6, 2018

(54) COMPUTER-BASED METHOD AND SYSTEM FOR AUTOMATICALLY GENERATING A BUILDING PLAN

(71) Applicant: Aditazz, Inc., Brisbane, CA (US)

(72) Inventors: Chih Teh Shen, Mountain View, CA (US); Robert Yu, Union City, CA (US); Suhas Belgal, Los Gatos, CA (US); Chuck Han, San Francisco, CA (US)

(73) Assignee: Aditazz, Inc., Brisbane, CA (US)

(21) Appl. No.: 15/449,832

(22) Filed: Mar. 3, 2017

(51) Int. Cl. G06F 17/50

(52) U.S. Cl. CPC G06F 17/5004

(57) ABSTRACT

In an embodiment, a method for automatically generating a building plan is disclosed. The method involves obtaining a set of architectural rules that define a set of tenant types, wherein a tenant type is defined by at least one spatial preference, obtaining a set of financial rules that define financial objectives, wherein the financial objectives are defined as a function of at least tenant type, floor location, and tenancy type, and generating a space program, wherein the space program indicates placement of tenant types as a function of the set of architectural rules and the set of financial rules; and generating building plan, wherein the building plan visualizes the placement of tenant types.

### BACKGROUND

Buildings are an integral part of everyday life. The process of planning, designing, and constructing buildings has evolved over several thousands of years. Typical steps followed to physically realize modern buildings can be complicated and may utilize a high degree of skilled labor that can span several different disciplines across the architecture, engineering, and construction industry. Additionally, the architectural, engineering, or construction decisions made in each step can be driven by financial decisions. Typically, financial decisions are made by a different group of experts than those that make the architectural, engineering, or construction decisions. This division of decision-making can pose a huge challenge in terms of time, money, and other resources expended in order to design and build a viable facility that can be used to deliver the intended services in an efficient and profitable way.

### SUMMARY

In an embodiment, a method for automatically generating a building plan is disclosed. The method involves obtaining a set of architectural rules that define a set of tenant types, wherein a tenant type is defined by at least one spatial preference, obtaining a set of financial rules that define financial objectives, wherein the financial objectives are defined as a function of at least tenant type, floor location, and tenancy type, and generating a space program, wherein the space program indicates placement of tenant types as a function of the set of architectural rules and the set of financial rules, and generating building plan, wherein the building plan visualizes the placement of tenant types.

In a second embodiment, generating a building plan further involves converting the set of architectural rules and the set of financial rules into constraint statements, writing the constraint statements to an input file, and feeding the input file to a constraint solver.

In another embodiment, the method further involves obtaining building parti and the building plan is generated as a function of the building parti.

In another embodiment, the building plan is generated while satisfying architectural rules defined to lock a particular tenant in a particular location within the building plan.

In another embodiment, the method further involves determining a projected financial return for the generated building plan and adding the building plan to a pool of possible building plans.

In another embodiment, the projected financial return for the generated building plan is determined based on a projected revenue return per area unit.

In another embodiment, the method further comprises comparing building plans in the pool of possible building plans and selecting a building plan based on at least one of the placement of tenant types within the building plan and the financial return for the building plan.

In another embodiment, a building plan generation system for automatically generating building plans is disclosed. The building plan generation system uses a computer having a memory, a processor, and a display, the memory comprising instructions that, when executed by the processor, perform steps involving obtaining a set of architectural rules that define a set of tenant types, wherein a tenant type is defined by at least one spatial preference, obtaining a set of financial rules that define financial objectives, wherein the financial objectives are defined as a function of at least tenant type, floor location, and tenancy type, and generating a space program, wherein the space program indicates placement of tenant types as a function of the set of architectural rules and the set of financial rules, and generating building plan, wherein the building plan visualizes the placement of tenant types.

In another embodiment, generating a building plan further involves converting the set of architectural rules and the set of financial rules into constraint statements, writing the constraint statements into an input file, and feeding the input file to a constraint solver.

In another embodiment, the building plan generation system further involves obtaining building parti and the building plan is generated as a function of the building parti.

In another embodiment, the building plan is generated while satisfying architectural rules defined to lock a particular tenant in a particular location within the building plan

In another embodiment, the steps further involve determining a projected financial return for the generated building plan and adding the building plan to a pool of possible building plans.

In another embodiment, the projected financial return for the generated building plan is determined based on a projected revenue return per area unit.

In another embodiment, the steps further involve comparing building plans in the pool of possible building plans and selecting a building plan based on at least one of the placement of tenant types within the building plan and the financial return for the building plan.

In another embodiment, a non-transitory computer-readable storage medium comprising instructions that, when executed by a computer, cause the computer to perform steps for automatically generating building plans is disclosed. In the embodiment, the steps involve obtaining a set of architectural rules that define a set of tenant types, wherein a tenant type is defined by at least one spatial preference, obtaining a set of financial rules that define financial objectives, wherein the financial objectives are defined as a function of at least tenant type, floor location, and tenancy type, and generating a space program, wherein the space program indicates placement of tenant types as a function of the set of architectural rules and the set of financial rules, and generating building plan, wherein the building plan visualizes the placement of tenant types.

In another embodiment, generating a building plan further involves converting the set of architectural rules and the set of financial rules into constraint statements, writing the constraint statements into an input file, and feeding the input file to a constraint solver.

In another embodiment, the steps further comprise obtaining building parti and the building plan is generated as a function of the building parti.

In another embodiment, the building plan is generated while satisfying architectural rules defined to lock a particular tenant in a particular location within the building plan

In another embodiment, the steps further involve determining a projected financial return for the generated building plan based on a projected revenue return per area unit and adding the building plan to a pool of possible building plans.

In another embodiment, the steps further comprise comparing building plans in the pool of possible building plans and selecting a building plan based on at least one of the placement of tenant types within the building plan and the financial return for the building plan.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a floor plan of a floor in building.

FIG. 2 is a flow chart diagram of a conventional process flow for planning and designing a building using a traditional human-based process.

FIG. 3 is a flow chart diagram of a process flow for automatically generating a building plan using a computer-based process.

FIG. 4 is a portion of a view of a graphical user interface for creating a new project.

FIG. 5 is a portion of a view of a graphical user interface for entering architectural rules.

FIG. 6 is a portion of a view of a graphical user interface for entering financial rules.

FIGS. 7A-7C show several examples of building parti.

FIG. 8 is a portion of a view of a graphical user interface for entering building parti.

FIG. 9 depicts a portion of an input file.

FIG. 10 is a portion of a view of a graphical user interface for displaying a generated space plan.

FIG. 11 shows a portion of a view of a graphical user interface for comparing generated building plans.

FIG. 12 depicts a block diagram of a computer.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

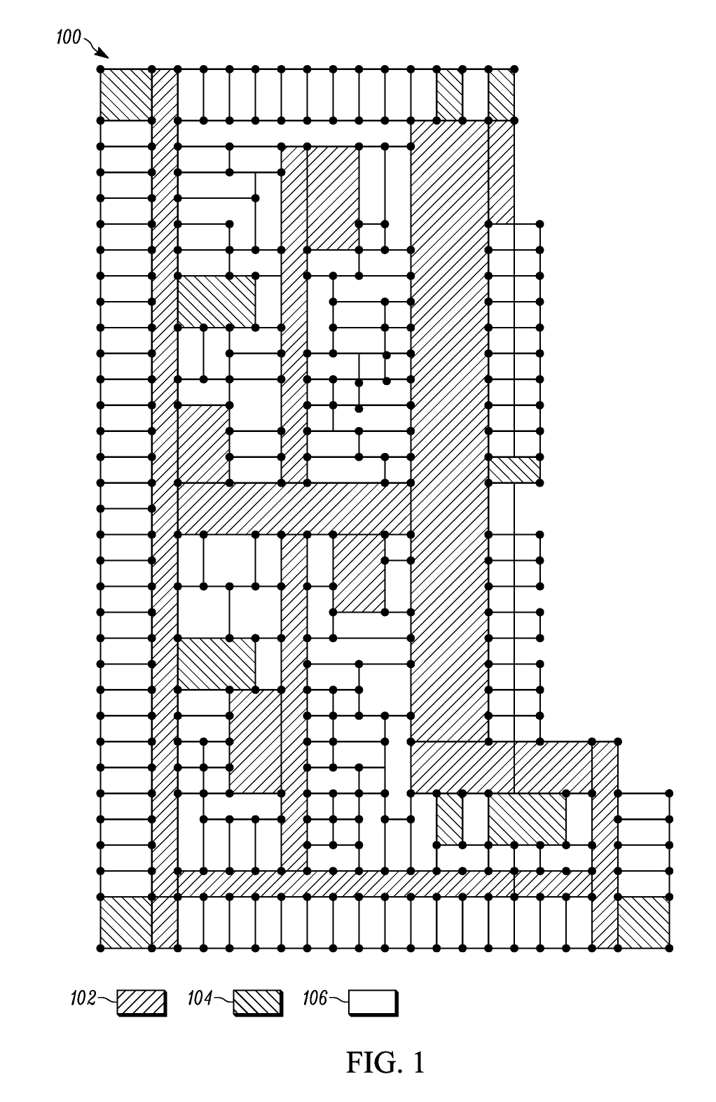

Delays caused by the division of financial decisions and architectural, engineering, or construction decisions between two groups may plague the planning, designing, and constructing of many types of buildings. For simplicity, embodiments of the invention will be explained in the context of planning, designing, and constructing a shopping mall. However, the techniques are applicable to other types of buildings, such as, for example, a building with mixed use between residential and retail, a manufacturing space, a transportation hub such as airport or train station, or a medical building such as a hospital. Typically, a building will have multiple floors or basements and each floor or basement can have a different floor plan. FIG. 1 depicts a floor plan 100 of a floor in a building. In the example of FIG. 1, the building is a shopping mall and the floor plan includes circulation 102 (e.g., walkways), building core components 104 (e.g., stairs, elevator shafts, and support structures), and various-sized retail spaces 106. In other more general embodiments, the various-sized retail spaces can be related to the function of the building. For example, the retail spaces can, instead, be procedure and patient rooms in a hospital or conference rooms and offices in an office building.

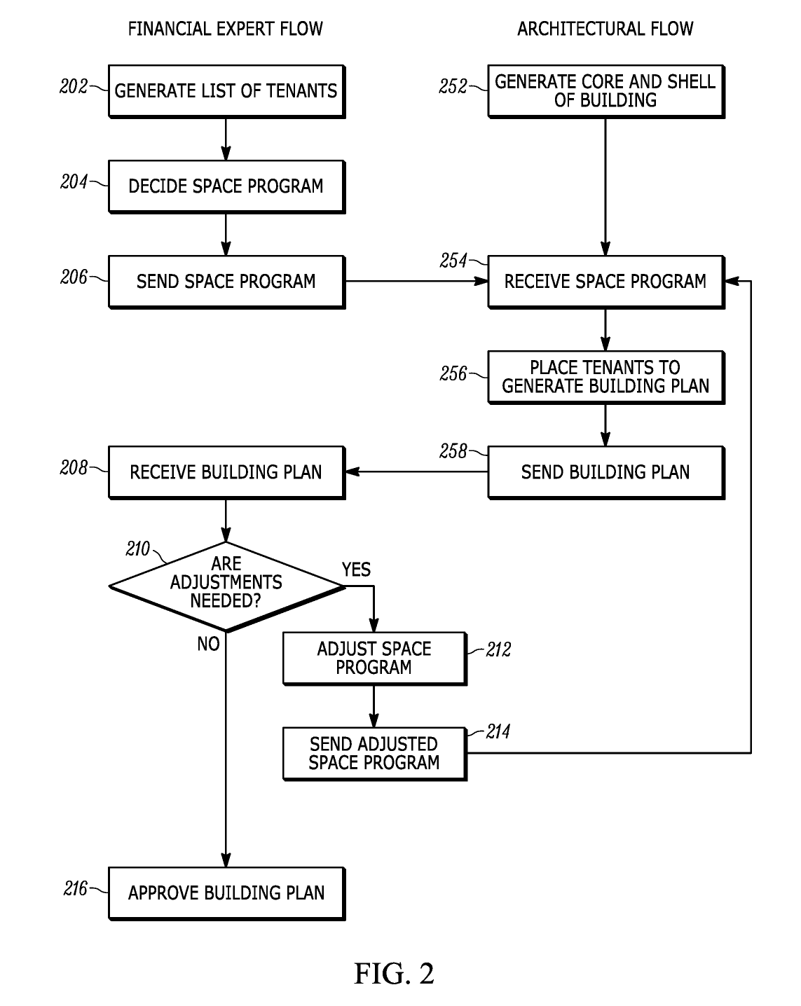

Typically, when a building such as a shopping mall is planned and designed, developers or project owners are driven to plan and design the building to maximize revenue, while architectural firms are driven by limitations on designs imposed by, for example, building dimensions or other features of the building. FIG. 2 is a flow chart diagram of a conventional process for the planning and designing of a building using a traditional human-based process. The flow chart diagram highlights the division of decision-making. The tasks of the process are divided between financial experts and architectural experts and, as illustrated in FIG. 2, both groups of experts can begin their respective task independent of each other. For example, financial experts calculate desired financial results for the building and then, at block 202, the financial experts generate a list of possible tenants that would satisfy the financial results (e.g., typically based on past human experience). At block 204, the financial experts decide on a space program for the building. The space program can include information for each tenant such as the spacing (e.g., square footage) and on which floor a particular tenant should be placed in order to maximize revenue. Typically, financial experts decide on the space program by using approximations and guesses educated by experience gained from working in the industry. That is, without the use of definite metrics. For example, the financial experts may decide that tenant A should get 1,200 square feet of space on the first floor, tenant B should get 600 square feet of space on the second floor, and tenant C should get 2,000 square feet on the basement floor. Meanwhile, at block 252, architectural experts generate a core and shell of a building. In an embodiment, the core and shell is a basic plan of dimensions matching the building to be planned and designed (e.g., the shape of a building when empty of any tenants). Architectural experts then further define tenant spaces (e.g., stores) within the building dimensions using knowledge or expertise of the trade. At block 206, the financial experts send the space program to the architectural experts and the space program is received at block 254. The financial experts then wait while, at block 256, the architectural experts place the tenants on their assigned floors within the building core and shell plan to generate a building plan. If the architectural experts are unable to place the tenants as assigned, the architectural experts make adjustments (e.g., move tenants to a floor different than assigned or reduce the square footage given to a tenant) as needed to fit all of the tenants within the building plan. At block 258, the building plan is sent to the financial experts and the building plan is received at block 208. The architectural experts then wait while the financial experts determine if adjustments are needed at decision point 210. In an embodiment, adjustments may be needed if the architectural experts are unable to place all of the tenants on their assigned floors and the adjusted building plan violates the space program or other financial rules (e.g., a sporting goods tenant assigned to the second floor was moved to a basement floor, which the tenant explicitly contracted against). Additionally, if on-going negotiations with tenants changes the space program (e.g., if tenant A leases 2,000 square feet of space), then adjustments to the building plan may be needed. If adjustments are not needed, then, at block 216, the building plan is approved. However, if adjustments are needed, then, at block 212, the financial experts adjust the space program and, at block 214, send the adjusted space program back to the architectural experts and the space program is again received at block 254. The process remains stuck in a loop until the financial experts approve the building plan. However, due to fee arrangements, only a limited number of adjustments can typically be made before budgetary constraints are exhausted and so the optimal solution (e.g., one which maximizes profits) is rarely reached. Additionally, this back-and-forth process can greatly delay the development of a building.

In accordance with an embodiment of the invention, a computer-based method for automatically generating a building plan is disclosed. In the embodiment, the method involves obtaining a set of architectural rules that define a set of tenant types, wherein a tenant type is defined by at least one of spatial parameters and client parameters, obtaining a set of financial rules that define financial objectives, wherein the financial objectives are defined as a function of at least tenant type, floor location, and tenancy type, and generating a building plan, wherein the building plan indicates the placement of tenant types as a function of the set of architectural rules and the set of financial rules. Thus, financial and architectural considerations can be automatically and simultaneously addressed as a function of financial and architectural rules. Accordingly, by defining financial goals and building dimensions as constraints, a constraint solver can be used to automatically generate a building plan that is physically possible and that satisfies financial constraints (e.g., maximizes the revenue output of the building) in a streamlined process. Thus, the amount of time, money, and other resources expended in order to plan and develop a building plan is reduced.

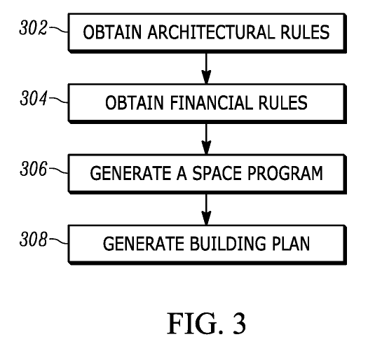

In an embodiment, automatically generating a building plan in accordance with an embodiment of the invention results in a streamlined computer process. FIG. 3 is a flow chart diagram of a process flow for automatically generating a building plan using a computer-based process. At block 302, architectural rules that define a set of tenant types are obtained. In an embodiment, a tenant type is defined by spatial parameters, such as minimum and maximum area occupied or floor designation, and by client parameters, such as tenancy type, but can be defined by other parameters as well. The architectural rules can be manually entered by a user or automatically created by an external application and stored in memory as a file or library. At block 304, financial rules that define financial objectives are obtained. In an embodiment, financial objectives are defined by establishing a number of retails spaces that should be sold to a tenant, a number of retail spaces that should be leased to a tenant, a number of retail spaces of which the owner should retain ownership, and a number of retail spaces that should be sold and leased back to the owner for each floor. Alternatively, the financial rules can be the projected revenue per area unit for each tenant depending on the tenancy type and on which floor the tenant is placed. In other embodiments, additional parameters can be used to define financial objectives. The financial rules can be manually entered by a user or automatically created by an external application and stored in memory as a file or library. The files or libraries storing the architectural rules and the financial rules are fed into a constraint solver and, at block 306, a building plan is generated.

While both a human-based process and a computer-based process result in the planning and development of a building plan, the two processes achieve their respective results in fundamentally different ways. By defining architectural and financial rules and evaluating those rules, a building plan can be planned and developed, for example, while delays caused by communication between separate groups of experts can be reduced and considerably more possible building plans can be evaluated. As a result, the process of generating a building plan is improved at least because a building plan with a known projected return can be generated more quickly than when using the human-based process.

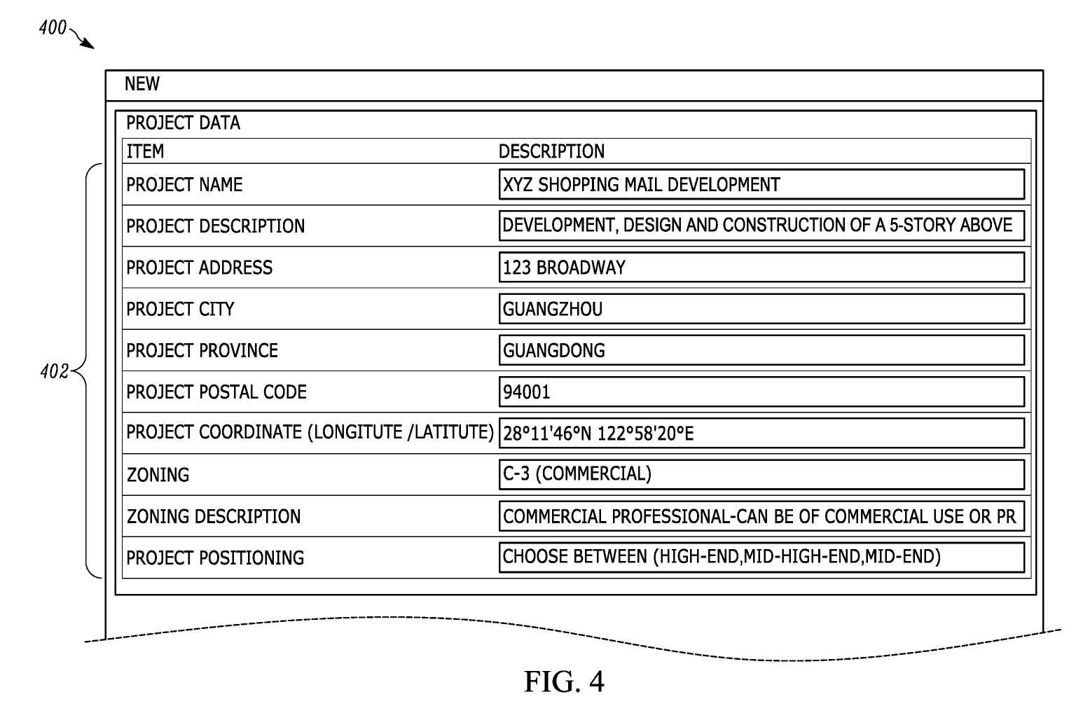

In an embodiment, the computer-based process can be implemented using a building plan generation system. In an embodiment, the building plan generation system is implemented using a graphical user interface run on a computer. FIGS. 4-11 illustrate embodiments of the user interface.

In order to plan and design a building plan using the computer-based process, a user begins by creating a new project. FIG. 4 is a portion of a view 400 of the graphical user interface for creating a new project. In an embodiment, a new project is created by entering basic information 402 about a building project. For example, the basic information can include a name of the project, a description of the project, address information for where the building will be built, zoning information, and building massing parameters (e.g., dimensions of the building shell and orientation). In an embodiment, the basic information is used to identify the new project, but can also be used to pre-define the architectural and financial rules in later views of the graphical user interface.

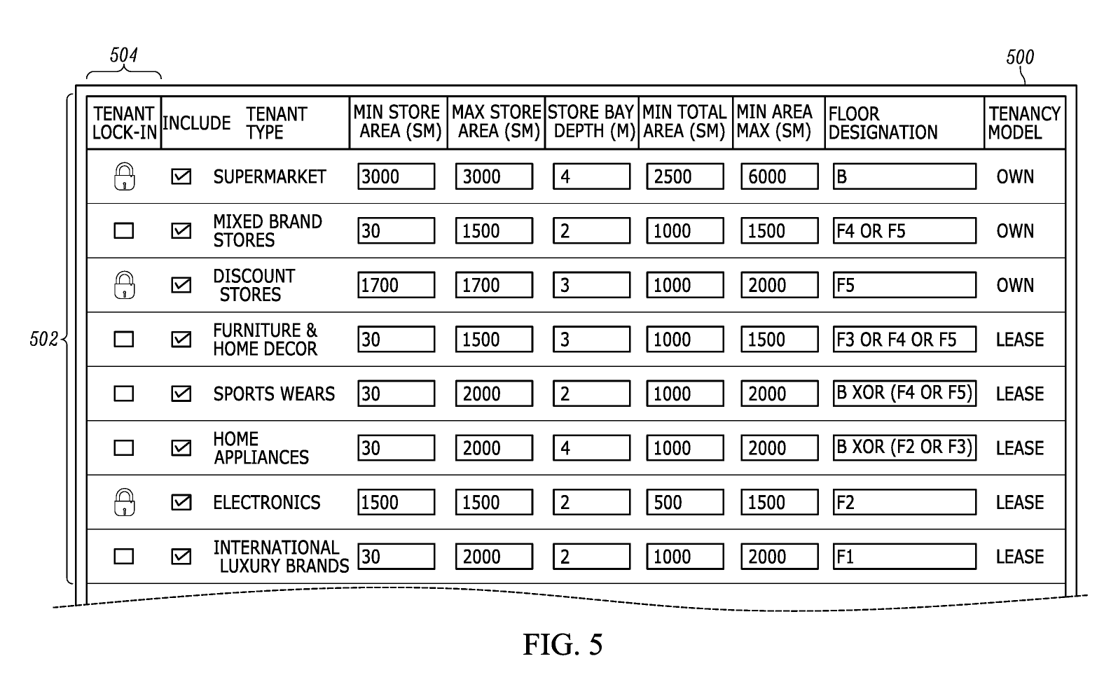

Once the project has been created, architectural rules can be obtained, for example, from a file or a library stored in computer memory. FIG. 5 is a portion of a view of the graphical user interface for entering architectural rules. As shown, the architectural rules can be entered into a table 500 having rows 502 for each tenant type and columns for entering one or more types of information about each tenant type. In an embodiment, an architectural rule is defined for each tenant type by entering information regarding spatial preferences for a given tenant type. In an embodiment, information regarding spatial preferences can include information such as a minimum and maximum area to be occupied by each instance of a tenant type, a number of bays to be occupied by each instance of a tenant type, a minimum and maximum area to be occupied by all instances of a tenant type, a floor designation, a tenancy type, a region of a floor, or additional information particular to a specific tenant (e.g., near elevator or on a corner with two entrances). Once entered, the architectural rules can be stored as a file or library in computer memory.

In an embodiment, a user can define architectural rules to manually lock a particular tenant in a particular retail space (e.g., a location within a building plan). For example, if a tenant signs a lease agreement, then the tenant can be locked to its retail space and the tool will generate space programs and building plans with the signed tenant in its leased retail space. As shown in FIG. 5, the graphical user interface can be used to lock a tenant by clicking the box in each row corresponding to the “lock-in” column 504. If a lock icon is indicated, then the tenant is locked and a space program with the tenant in the position specified by the spatial preferences will be generated. In an embodiment, the special preferences of a locked tenant can be more specific than an unlocked tenant. That is, rather than defining a range between the minimum store area and the maximum store area, the minimum and maximum store area can be the same number and equal to the exact area leased to the locked tenant. For example, in FIG. 5, the Supermarket type tenant is locked. The value entered in the min store area and max store area columns is 3000, which reflects the area specified in a lease agreement.

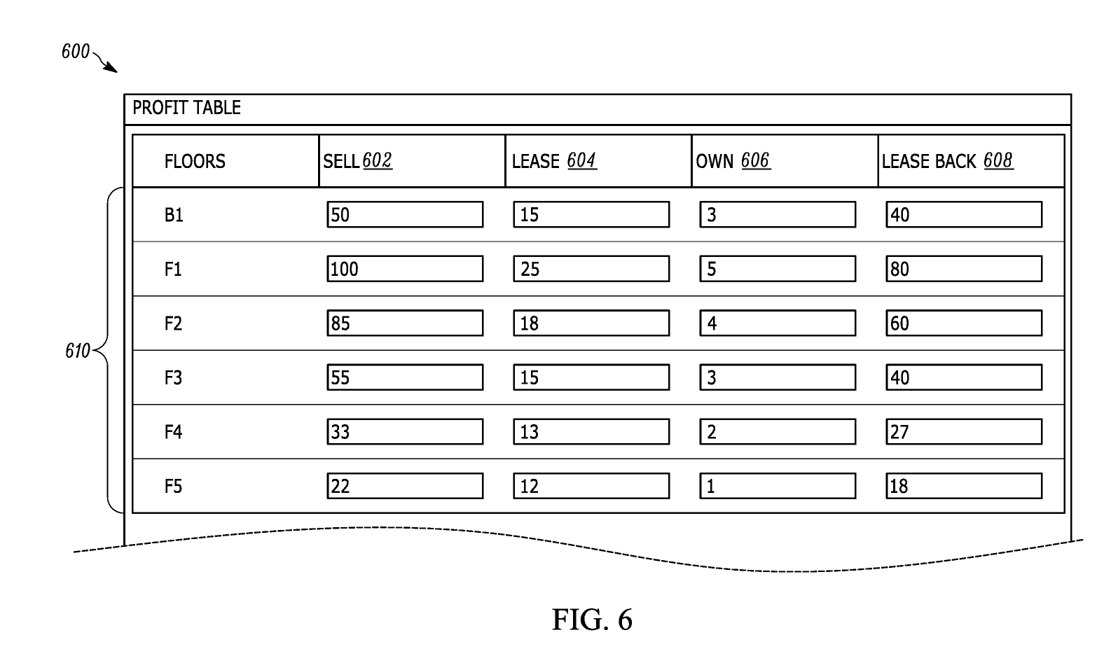

In another view of the graphical user interface, financial rules can be obtained, for example, from a file or a library stored in computer memory. FIG. 6 is a portion of a view 600 of the graphical user interface for entering financial rules. As shown, the financial rules can be entered into a table 600 having rows for each floor 610 and columns for entering the number of each tenancy type 602-608 per floor. That is, the income generated by a retail space if it is sold to a tenant, leased to a tenant, retained by the building owner, or sold and leased back to the building owner can be entered for each floor. While not shown, additional variables such as lease term, annual lease escalation, annual expenses, or project profits for the tenant, can be entered into the table as well in order to determine projected revenue. In an embodiment, the projected revenue given a set of variables (e.g., floor, space, tenancy type) can be determined based on third party evaluations, past experience, or actual values calculated from signed agreements. Once entered, the financial rules can be stored as a file or library in computer memory.

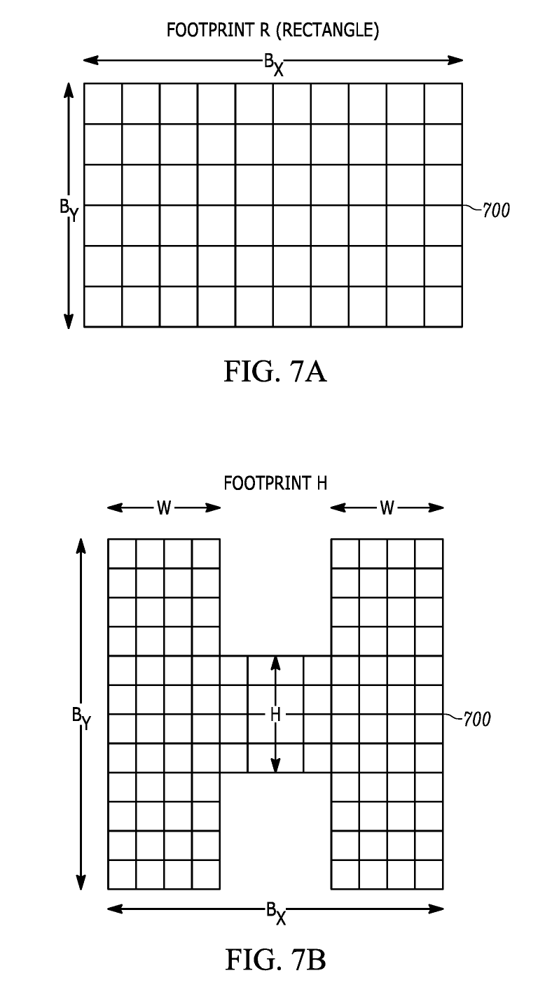

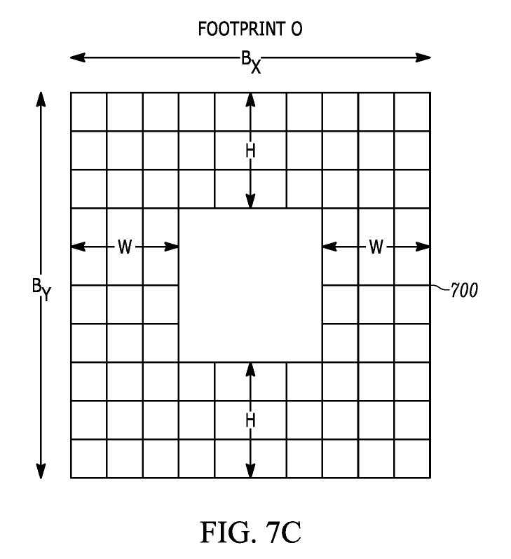

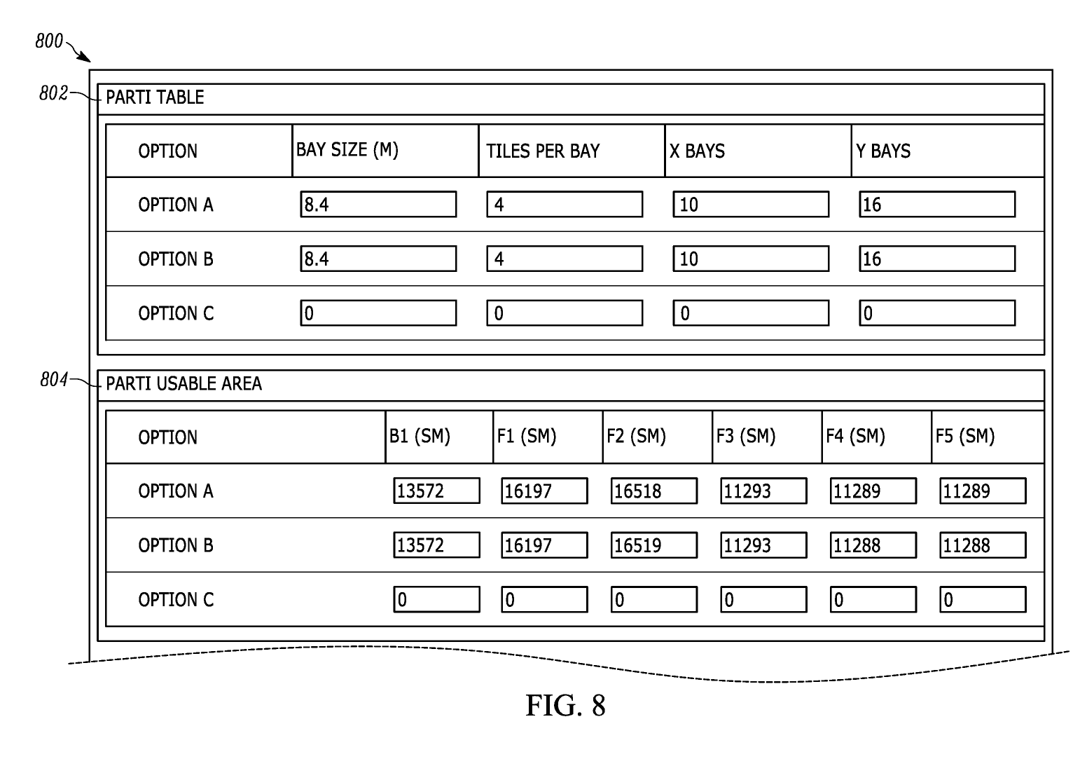

Optionally, once the architectural rules and the financial rules have been defined, additional information can be provided about the building in the form of building parti, for example, from additional files or libraries created by a user or generated automatically by an external application. FIGS. 7A-7C show several examples of building parti 700. Each parti is made up of several bays, as indicated by cells in the figures. Furthermore, each parti has measurements indicating the number of bays along an x-dimension (B_{X}) and the number of bays along a y-dimension (B_{Y}) of the parti. FIG. 8 is a portion of a view 800 of the graphical user interface for entering building parti. As shown, a building parti can be entered in a first table 802 having rows for various parti options and columns for entering the dimensions of a bay in a parti, a number of tiles that make up a bay, a number of bays along an x-dimension of the parti, and a number of bays along a y-dimension of the parti. The usable area in a building parti can be entered in a second table 804 that has rows for each row in the first table and columns for the total usable area for each floor of the parti.

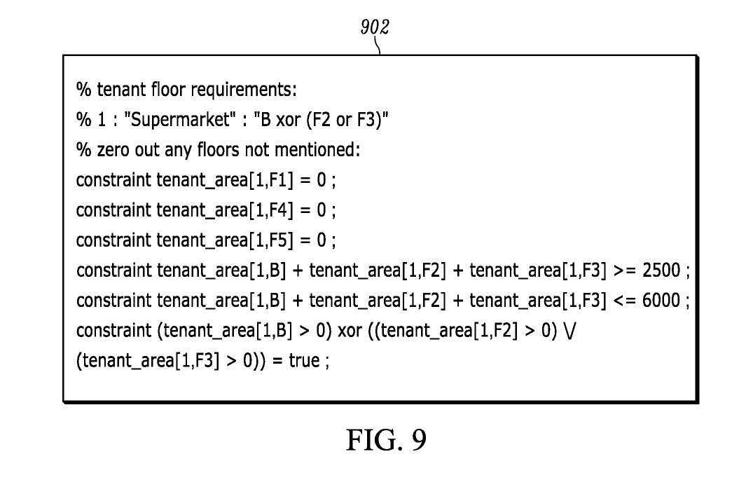

Once the architectural and financial rules have been obtained, they can be converted into constraint statements, written to an input file, and the input file can be fed to a constraint solver. In an embodiment, the constraint statements can be written in plain text using the MiniZinc constraint modeling language, but other modeling languages could be used. FIG. 9 depicts a portion 902 of the input file, while the full input file may contain multiple constraint statements corresponding to one or more architectural or financial rules. For example, an architectural rule that places supermarket tenants in the basement or on the second or third floor and limits each tenant area to between 2500 and 6000 area units can be converted into the constraint statements shown in FIG. 9. Similarly, the dimensions of a locked tenant, as described with reference to FIG. 5, can be converted into a constraint statement, as well. In an embodiment, the architectural and financial rules are converted into constraint statements automatically by the building constraint system by manipulating parameters of the architectural and financial rules stored in the files or libraries. For example, parameters indicating a minimum and maximum store area, as defined in architectural rules, can be substituted for corresponding defined variables in a pre-defined constraint statement. By converting the architectural rules and financial rules to constraint statements, the rules can be reapplied to different building shapes (e.g., as defined by the building parti).

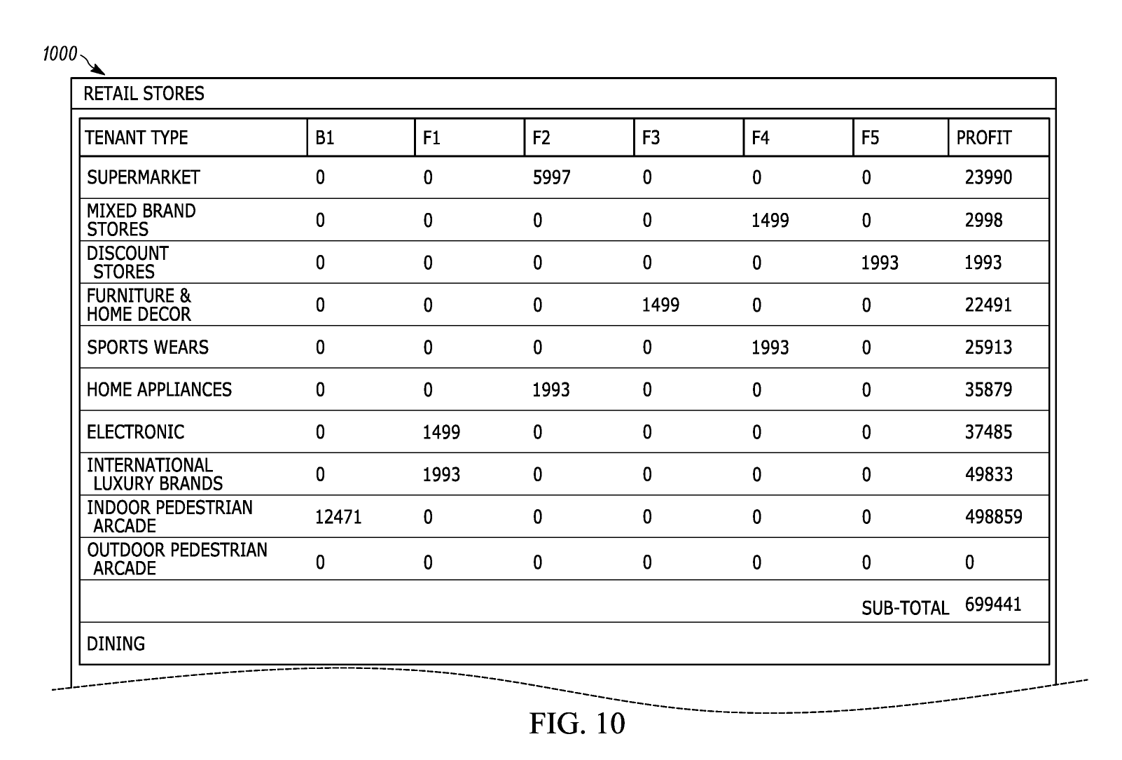

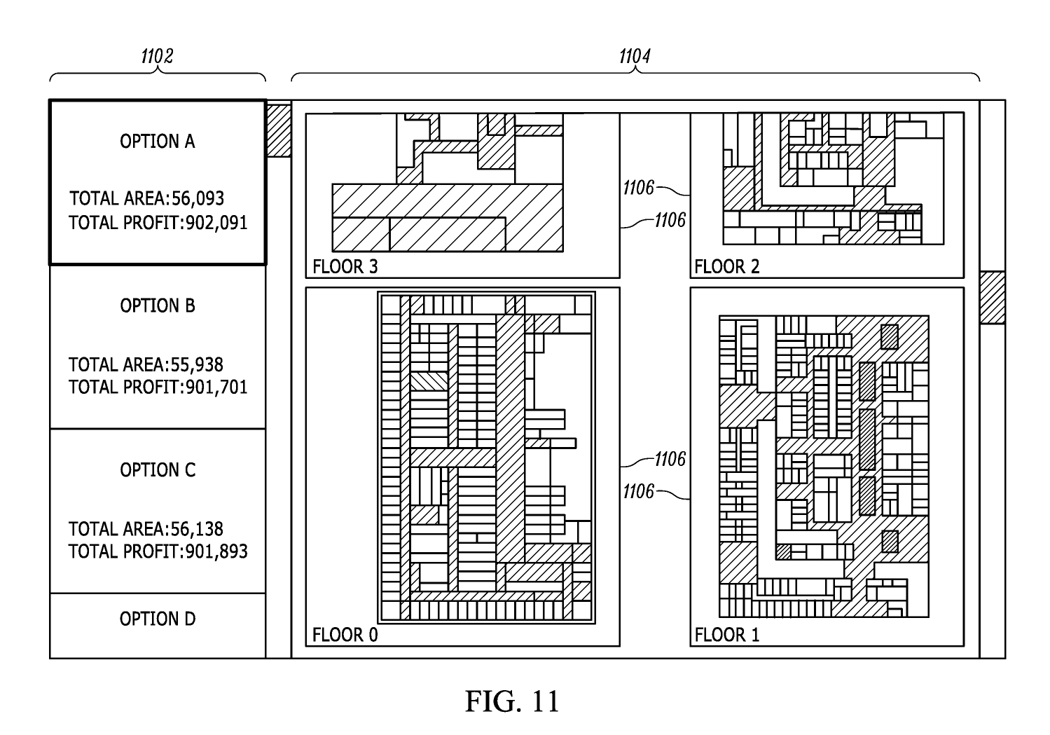

In an embodiment, the input file is then fed to a constraint solver and a space program is generated as a function of the set of architectural rules and the set of financial rules. A constraint solver is an engine for solving constraint problems by determining a solution that satisfies constraint statements received as inputs. Known examples of constraint solvers include, for example, the Choco solver, the Chuffed solver, the Mistral 2.0 solver, or the Yuck solver. In an embodiment, the constraint solver finds a solution that satisfies the constraint statements converted from the architectural rules and the financial rules. Additionally, if the placement of tenants has been manually locked (e.g., a grocery is locked in a center location on the second floor), then the constraint solver can be configured to find a solution, while preserving the locked placement of the tenants. FIG. 10 is a portion of a view 1000 of the graphical user interface for displaying a generated space program. In an embodiment, the space program indicates on which floors what types of tenants should be placed, the total area that should be allocated to each tenant type on a floor, and the projected financial return from the generated space program. In an embodiment, the projected financial return for a generated space program is determined based on the projected revenue return per area unit for a given tenant type with a given tenancy type (e.g., the information entered with reference to FIG. 6). By generating a space program as a function of the set of architectural rules and the set of financial rules using a computer-implemented constraint solver, a computer system, such as a building plan generation system, can be utilized to generate multiple space programs in a timely manner for evaluation without, for example, exhausting budgetary constraints. Additionally, if additional architectural rules or financial rules need to be subsequently added after a space program has been generated, the additional architectural rules or financial rules can be fed into the constraint solver and the space program can also be updated in a timely manner.

In an embodiment, multiple space programs can be generated and placed in a pool of possible space programs. The space programs can then be fed into a room placer and a building plan can be generated. In an embodiment, multiple space programs and building plans can be viewed simultaneously and compared. FIG. 11 shows a portion of a view 1100 of the graphical user interface for comparing generated space programs and building plans. In an embodiment, generated space programs and building plans can be organized or sorted by the projected revenue for a given space program or building plan. Additionally, the building plan generation system can automatically select a building plan from the pool of building plans by comparing building plans in the pool of possible building plans based on at least one of the placement of tenant types within the building plan and the financial return for the building plan. The selected building plan can then be output to the user.

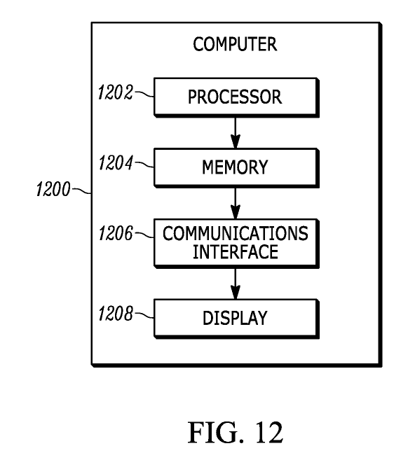

FIG. 12 depicts a block diagram of a computer 1200 that can be used to implement the above-described techniques. In an embodiment, the computer includes a processor 1202, memory 1204, a communications interface 1206, and a display 1208. The processor may include a multifunction processor and/or an application-specific processor. Examples of processors include the PowerPC™ family of processors by IBM and the x86 family of processors by Intel, such as the Xeon™ family of processors and the Intel X5650 processor. The memory within the computer may include, for example, a non-transitory storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a non-transitory computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a non-transitory computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for automatically generating a building plan, the method comprising:
obtaining a set of architectural rules that define a set of tenant types, wherein a tenant type is defined by at least one spatial preference;
obtaining a set of financial rules that define financial objectives, wherein the financial objectives are defined as a function of at least tenant type, floor location, and tenancy type;
generating a space program, wherein the space program indicates placement of tenant types as a function of the set of architectural rules and the set of financial rules; and
generating a building plan, wherein the building plan visualizes the placement of tenant types.

2. The method of claim 1, wherein generating a building plan further comprises:
converting the set of architectural rules and the set of financial rules into constraint statements;
writing the constraint statements to an input file; and
feeding the input file to a constraint solver.

3. The method of claim 1, wherein the method further comprises obtaining building parti and wherein the building plan is generated as a function of the building parti.

4. The method of claim 1, wherein the building plan is generated while satisfying architectural rules defined to lock a particular tenant in a particular location within the building plan.

5. The method of claim 1, wherein the method further comprises:
determining a projected financial return for the generated building plan; and
adding the building plan to a pool of possible building plans.

6. The method of claim 5, wherein the projected financial return for the generated building plan is determined based on a projected revenue return per area unit.

7. The method of claim 5, wherein the method further comprises comparing building plans in the pool of possible building plans and selecting a building plan based on at least one of the placement of tenant types within the building plan and the financial return for the building plan.

8. A building plan generation system for automatically generating building plans using a computer having a memory, a processor, and a display, the memory comprising instructions that, when executed by the processor, perform steps comprising:
obtaining a set of architectural rules that define a set of tenant types, wherein a tenant type is defined by at least one spatial preference;
obtaining a set of financial rules that define financial objectives, wherein the financial objectives are defined as a function of at least tenant type, floor location, and tenancy type;
generating a space program, wherein the space program indicates placement of tenant types as a function of the set of architectural rules and the set of financial rules; and
generating a building plan, wherein the building plan visualizes the placement of tenant types.

9. The building plan generation system of claim 8, wherein generating a building plan further comprises:
converting the set of architectural rules and the set of financial rules into constraint statements;
writing the constraint statements into an input file; and
feeding the input file to a constraint solver.

10. The building plan generation system of claim 8, wherein the building plan generation system further comprises obtaining building parti and wherein the building plan is generated as a function of the building parti.

11. The building plan generation system of claim 8, wherein the building plan is generated while satisfying architectural rules defined to lock a particular tenant in a particular location within the building plan.

12. The building plan generation system of claim 8, wherein the steps further comprise:
determining a projected financial return for the generated building plan; and
adding the building plan to a pool of possible building plans.

13. The building plan generation system of claim 12, wherein the projected financial return for the generated building plan is determined based on a projected revenue return per area unit.

14. The building plan generation system of claim 12, wherein the steps further comprise comparing building plans in the pool of possible building plans and selecting a building plan based on at least one of the placement of tenant types within the building plan and the financial return for the building plan.

15. A non-transitory computer-readable storage medium comprising instructions that, when executed by a computer, cause the computer to perform steps for automatically generating building plans, the steps comprising:
obtaining a set of architectural rules that define a set of tenant types, wherein a tenant type is defined by at least one spatial preference;
obtaining a set of financial rules that define financial objectives, wherein the financial objectives are defined as a function of at least tenant type, floor location, and tenancy type;
generating a space program, wherein the space program indicates placement of tenant types as a function of the set of architectural rules and the set of financial rules; and
generating a building plan, wherein the building plan visualizes the placement of tenant types.

16. The non-transitory computer-readable storage medium of claim 15, wherein generating a building plan further comprises:
converting the set of architectural rules and the set of financial rules into constraint statements;
writing the constraint statements into an input file; and
feeding the input file to a constraint solver.

17. The non-transitory computer-readable storage medium of claim 15, wherein the steps further comprise obtaining building parti and wherein the building plan is generated as a function of the building parti.

18. The non-transitory computer-readable storage medium of claim 15, wherein the building plan is generated while satisfying architectural rules defined to lock a particular tenant in a particular location within the building plan.

19. The non-transitory computer-readable storage medium of claim 15, wherein the steps further comprise:
determining a projected financial return for the generated building plan based on a projected revenue return per area unit; and
adding the building plan to a pool of possible building plans.

20. The non-transitory computer-readable storage medium of claim 19, wherein the steps further comprise comparing building plans in the pool of possible building plans and selecting a building plan based on at least one of the placement of tenant types within the building plan and the financial return for the building plan.
